(19) United States
(12) Patent Application Publication
(10) Pub. No.: US 2014/0331238 A1
(43) Pub. Date: Nov. 6, 2014

(54) ELECTRONIC DEVICE AND METHOD FOR CONTROLLING APPLICATION TO EXECUTE INPUT COMMAND

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-SEN LIANG, Shenzhen (CN); CHIH-SAN CHIANG, New Taipei (TW); HUA-DONG CHENG, Shenzhen (CN); LING-JUAN JIANG, Shenzhen (CN)

(73) Assignees: Fu Tai Hua Industry (Shenzhen) Co., Ltd., Shenzhen (CN); HON HAI PRECISION INDUSTRY CO., LTD., New Taipei (TW)

(21) Appl. No.: 14/264,305

(22) Filed: Apr. 29, 2014

(30) Foreign Application Priority Data
May 3, 2013 (CN) 2013101601580

(51) Int. Cl. G06F 9/54

(52) U.S. Cl. CPC G06F 9/54
USPC 719/320

(57) ABSTRACT

Method for controlling a number of applications to execute input commands simultaneously comprises determining whether a share command is generated and identifying currently running applications when the share command is generated. The general input commands are received and are copied. At least one background application is controlled to execute the copied general input commands. An electronic device using the above method is also provided.

### FIELD

The present disclosure relates to an electronic device and a method for controlling application to execute an input command of the electronic device.

### BACKGROUND

In modern computing devices, multitask operating operations are widely used and the computing devices allow multiple programs to run simultaneously. Typically, only one of the running applications can receive an input command in response to an input of a user and execute an operation associated with the input command. The other running applications cannot receive the input command.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an embodiment of an electronic device.

FIG. 2 is a flowchart of a method for controlling applications to execute an input command of electronic devices, such as the one of the FIG. 1.

### DETAILED DESCRIPTION

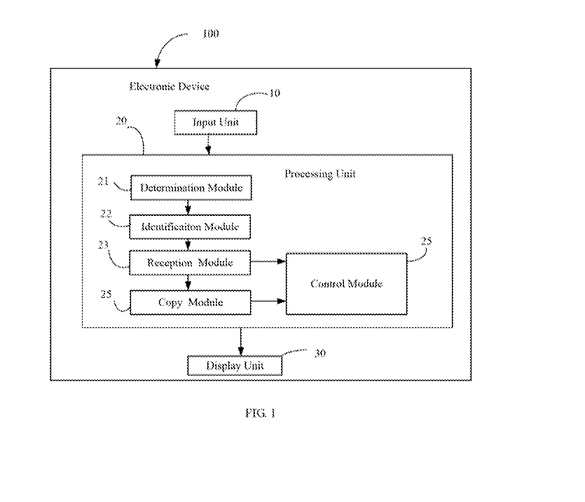

FIG. 1 illustrates an electronic device 100. The electronic device 100 includes an input unit 10, a processing unit 20 and a display unit 30. Each window interface displayed on the display unit 30 is associated with an application that is running on the electronic device 100. The input unit 10 can be a keyboard, or a touch screen. In at least one embodiment, the electronic device 100 is an electronic reader. The current running applications can include an office word document, an office excel document, a screensaver, a web browser, for example.

The input unit 10 is connected to the processing unit 20 and generates an input command in response to an input operation of a user. The input command can be a share command or a general input command depending on the type of the input operation. For example, the share command is generated in response to a predefined input operation A, and the general command is generated in response to other input operations that are different from the input operation A. The share command is to control two currently running applications to share a same general input command.

The processing unit 20 can include a determination module 21, an identification module 22, a reception module 23, a copy module 24, and a control module 25.

The determination module 21 determines if the input unit 10 generates a share command. When the input unit 10 generates a share command, the identification module 22 indentifies the current applications running on the electronic device 100. The current running applications can include an application running in the foreground that currently has the input cursor (hereinafter “foreground application”) and at least one application running in the background that currently does not have the input cursor (hereinafter “background application”). In at least one embodiment, the foreground application is a first office word document; one of the at least one background application is a second office word document.

The reception module 23 receives general input commands and the copy module 24 copies the general input commands if the input unit 10 has generated the share command.

The control module 25 controls the foreground application to execute the general input commands received by the reception module 23 and further controls one background application to execute the same general input commands copied by the copy module 24.

In an alternative embodiment, the identification module 22 identifies one or more background applications that can receive general input operations of a user. In at least one embodiment, the identification module 22 identifies a background application receiving general input operations of a user when the background application has at least one input function. If only one background application can receive general input operations of a user, the control module 25 controls the background application to execute the copied command. If more than one background applications can receive general input operations of a user, the identification module 26 further identifies the operation frequency of each of background applications. In the embodiment, the operation frequency of a background application is the frequency that the application is manipulated by the user in a predefine time length. The control module 25 also controls the background application with the highest operation frequency to execute the copied general input commands.

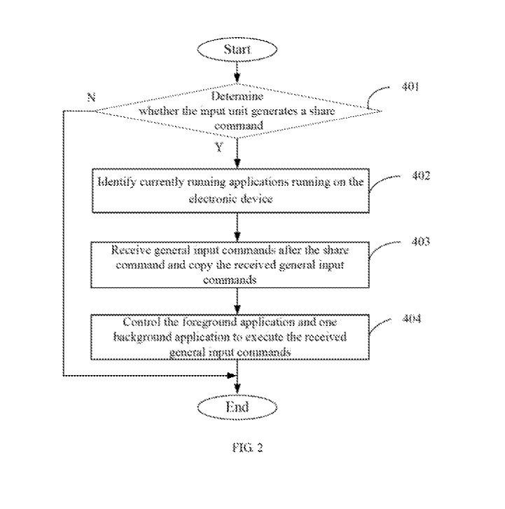

FIG. 2 illustrates a flowchart of a method for controlling application to execute an input command. The method is applied to the electronic device 100 and includes steps, each of which is related to the various components contained in the electronic device 100.

In block 401, the determination module determines whether the input unit generates a share command associating with an input operation of a user. If a share command is generated, the process goes to block 402; if a share command is not generated, the process ends.

In block 402, the identification module identifies the currently running applications running on the electronic device 100. The current running applications can include a foreground application and at least one background application.

In at least one embodiment, the second control module identifies one or more background applications that can receive general input operations of a user. If more than one background application can receive input operations of a user, the second control module identifies the operation frequency of each of background applications.

In block 403, the reception module receives general input commands, the copy module copies the general input commands after the share command.

In block 404, the control module controls the foreground application to execute the general input commands received by the reception module and controls one background application to execute the general input commands copied by the copy module .

In at least one embodiment, if only one background application can receive general input operations of a user, the control module 25 controls the background application to execute the copied commands. If more than one background application can receive input operations of a user, the control module 25 controls the background application with the highest operation frequency to execute the copied commands.

The electronic device 100 copies the input commands and controls one of the background applications to execute the copied input commands, thus two running applications share an input command, reducing the number of input operations.

Although the present disclosure has been described in considerable with reference to certain preferred embodiments thereof, the disclosure is not for limiting the scope of the present disclosure. Persons having ordinary skill in the art can make various modifications and changes without departing from the scope and spirit of the disclosure. Therefore, the scope of the appended claims should not be limited to the description of the preferred embodiments described above.

What is claimed is:

1. An electronic device, comprising:
an input unit for generating input commands in response to input operations comprising share commands and general input commands, the share commands for controlling two currently running applications to share same general input commands; and
a processing unit including:
a determination module configured for determining whether the input unit generates a share command;
an identification module configured for identifying the currently running applications when the share command is generated, the current running applications comprising a foreground application and at least one background application;
a reception module configured for receiving general input commands after the input unit generates the share command;
a copy module configured for copying the general input commands after the share command; and
a control module configured for controlling one of the at least one background application to execute the general input commands copied by the copy module.

2. The electronic device as described in claim 1, wherein the identification module is also configured for identifying one or more background applications that are capable of receiving input operations.

3. The electronic device as described in claim 2, wherein when only one background application that is capable of receiving input operation, the control module controls the background application to execute the copied general input commands.

4. The electronic device as described in claim 2, wherein when more than one background applications are capable of receiving input operations, the identification module is configured to identify the operation frequency of each of the more than one background application, and the control module controls a background application with the highest operating frequency to execute the copied general input commands.

5. The electronic device as described in claim 2, wherein the identification module is configured to identify a background application that is capable of receiving input operations when the background application has at least one input function to receive general input operations.

6. The electronic device as described in claim 1, wherein the control module further controls the foreground application to execute the general input instruction received by the reception module.

7. A method for controlling applications to execute input commands, the method comprising:
determining whether a share command is generated;
identifying currently running applications when the share command is generated, the current running applications comprising a foreground application and at least one background application;
receiving general input commands and copying the general input commands; and
controlling one of the at least one background application to execute the copied general input commands.

8. The method as described in claim 7, further comprising identifying one or more background applications that are capable of receiving input operations.

9. The method as described in claim 8, wherein controlling one of the at least one background application to execute the copied input commands further comprises: when only one background application that is capable of receiving input operations, controlling the background application to execute the copied general input commands.

10. The method as described in claim 8, wherein controlling one of the at least one background application to execute the copied input commands further comprises: when more than one background application that are capable of receiving input operations, identifying the operation frequency of each of the more than one background application, and controlling a background application with the highest operation frequency to execute the copied general input command.

11. The method as described in claim 8, wherein a background application is identified to be capable of receiving input operations when the background application has at least one input function to receive the input operation.

12. The method as described in claim 7, further comprising controlling the foreground application to execute the received general input commands.
